(19) United States
(12) Patent Application Publication
(10) Pub. No.: US 2026/0062973 A1
(43) Pub. Date: Mar. 5, 2026

(54) PIVOT DOOR SYSTEM WITH INDEPENDENT HINGED PANEL

(71) Applicant: Endura Products, LLC, Colfax, NC (US)

(72) Inventors: Bruce PROCTON, Greensboro, NC (US); Tomasz JASKIEWICZ, Oak Ridge, NC (US); Adam KENDALL, Burlington, NC (US); Chris Keziah, Colfax, NC (US); Jesus Palma, Colfax, NC (US)

(21) Appl. No.: 18/819,614

(22) Filed: Aug. 29, 2024

Related U.S. Application Data
(60) Provisional application No. 63/535,099, filed on Aug. 29, 2023.

(51) Int. Cl. E05D 15/48; E05D 3/02; E05D 7/083; E05D 11/10; E06B 3/50

(52) U.S. Cl. CPC E05D 15/48; E05D 3/02; E05D 7/083; E05D 11/1007; E05D 11/1014; E06B 3/50

(57) ABSTRACT

A pivot door assembly is provided, including a primary panel, a secondary panel, and providing a pivot assembly and/or joining member with upper and lower pivot assemblies.

### CROSS REFERENCE TO RELATED APPLICATIONS

This application claims priority to U.S. Provisional Application Ser. No. 63/535,099 filed on Aug. 29, 2023, which is specifically incorporated herein by reference in its entirety, for any purpose, and to which priority is claimed.

### BACKGROUND

### 1 Technical Field

present disclosure relates to pivot door systems and, more specifically, to pivot door systems having an independent hinged panel.

### 2. Discussion of Related Art

Pivot doors provide both functional and aesthetic advantages compared to hinged doors. Hinged doors are attached and supported to a door frame along a vertical jamb edge by hinges. The larger the hinged door, the more hinges and the more substantial the door frame must be to support the hinged door. A pivot door is supported by a bottom pivot along a horizontal bottom edge of the door and aligned with a top pivot in a top edge of the door to secure the pivot door within the door frame. This structure allows a pivot door to be constructed as large, heavy doors without the need for a substantial door frame.

In part, the aesthetic appeal of a pivot door can be attributed to the function of the pivot door. In most cases, the hinges of a hinged door are visible from at least one side of the hinged door at all times. Locating the pivot points on the top edge and the bottom edge of the pivot door allows for near complete concealment of the pivot mechanisms between the edges of the pivot door and the door frame regardless of the position of the door. Further, the concealment of the pivot points and the pivot action of the pivot door makes the pivot door appear as if floating between the open and closed positions.

Additionally, all door panel installations are subject to both installation and manufacturing variations when they are installed. These variations are mostly caused by locational variations that cause issues with axis of swing. If the axis is misaligned, frictional force can be added to the door system, increasing the operational force of the door. Since pivot doors only require two locations to create the door's axis of rotation, they will produce less frictional forces into the system.

The present disclosure recognizes a need in the art for improvements to pivot doors that overcome and alleviate the above and other problems and disadvantages in the art.

### SUMMARY

This disclosure relates generally to a pivot door system having a pivot door including a primary panel and a secondary panel. The pivot door may open and close with the primary panel and the secondary panel moving in concert, or the secondary panel may open relative to the primary panel individually. The secondary panel may further be a sidelight, including a window.

In an aspect of the present disclosure, a pivot door assembly includes a primary panel, a secondary panel, and a pivot assembly. The primary panel has an inside face and an outside face opposite the inside face. The secondary panel has an inside face and an outside face opposite the inside face. The pivot assembly is configured to pivotally mount the pivot door assembly within a door frame. The pivot assembly is disposed between the primary panel and the secondary panel to rotatably secure the primary panel and the secondary panel to each other. The pivot assembly has a closed position in which the primary panel and the secondary panel are each engaged with the door frame with the inside face of the secondary panel parallel to the inside face of the primary panel. The pivot assembly has a first open position in which the primary panel and the secondary panel pivot away from the door frame with the inside face of the secondary parallel to the inside face of the primary panel. The pivot assembly has a second open position in which the inside face of the primary panel and the inside face of the secondary panel are askew from one another.

In another aspect of the present disclosure, a pivot hinge for a pivot door having a primary panel and a secondary panel includes a pivot assembly and a retainer mechanism. The pivot assembly is configured to pivotally mount the primary panel and the secondary panel such that the primary panel and the secondary panel are capable of pivoting relative to a door frame about a pivot axis and capable of pivoting relative to each other about a hinge axis. The pivot assembly defines the pivot axis between the primary panel and the secondary panel such that the primary panel and the secondary panel are pivotable about the pivot axis in concert with one another. The pivot assembly defines the hinge axis parallel to the pivot axis such that the secondary panel is pivotable about the hinge axis relative to the primary panel. The retainer mechanism is disposed between the primary panel and the secondary panel. The retainer mechanism has a locked state in which the pivot assembly is configured to pivot the primary panel and the secondary panel in concert with one another and an unlocked state in which the pivot assembly is configured to allow the secondary panel to pivot relative to the primary panel.

In another aspect of the present disclosure, a pivot door assembly includes a primary panel, a secondary panel, and a pivot assembly. The pivot assembly is configured to pivotally mount the pivot door assembly within a door frame defining an opening. The pivot assembly is disposed between the primary panel and the secondary panel to rotatably secure the primary panel and the secondary panel to each other. The pivot assembly has a closed position in which the primary panel and the secondary panel are configured to align with each other within a thickness of the door frame to fill the opening. The pivot assembly has a first open position in which the primary panel and the secondary panel are configured to pivot within the opening aligned with each other such that the opening is divided by the primary panel and the secondary panel with each of the primary panel and the secondary panel extending partially outside the thickness of the door frame. The pivot assembly has a second open position in which the primary panel and the secondary panel rotate relative to each other such that the primary panel and the secondary panel are askew from one another and are configured to pivot within the opening to divide the opening with at least one of the primary panel or the secondary panel extending partially outside the thickness of the door frame.

In another aspect of the present disclosure, a method of operating a pivot door system including a door frame and pivot door pivotally mounted in the door frame includes moving the pivot door system from a closed configuration to a first open configuration thereof, transitioning a retainer mechanism of the pivot door to an unlocked state thereof, and moving the pivot door system to a second configuration thereof.

In further exemplary aspects of the present disclosure, a lower pivot hinge includes a lower pivot having a lower portion configuration complementary to a pivot ball, such that the lower pivot hinge rotates on and across the ball joint to pivot the door assembly and to correct for installation or manufacturing tolerances during operation. Additional improvements to lower and upper pivot members and assemblies are also described herein.

In further exemplary aspects of the present disclosure, improvements to the joining of panels are described, e.g., using complementary shaped joining members having joining protrusion and recesses complementary to each other and recessed from the faces of the joining members to provide reduced or eliminated sight lines or seams.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a perspective view of a pivot door system in accordance with exemplary embodiments of the present disclosure with the pivot door system in a closed position thereof;

FIG. 2 is a perspective view of the pivot door system of FIG. 1 in a first open position thereof;

FIG. 3 is a perspective view of the pivot door system of FIG. 1 in a second open position thereof;

FIG. 4 is a section view of a lower pivot assembly of the pivot door system of FIG. 1 taken along the section line L-L;

FIG. 5 is a section view of an upper pivot assembly of the pivot door system of FIG. 1 taken along the section line U-U;

FIG. 6 is rear perspective view of a hinge assembly of the pivot door system of FIG. 3;

FIG. 7 is a front perspective view of the hinge assembly of FIG. 6;

FIG. 8 is a section view of a retention mechanism of the door pivot system of FIG. 1 taken along section line R-R with the retention mechanism in a locked state thereof;

FIG. 9 is a partially transparent perspective view of the hinge assembly of FIG. 6 with the pivot door system in the closed position, the primary and secondary panels hidden, and the retention mechanism in the locked state;

FIG. 10 is a section view of the retention mechanism of FIG. 8 with the retention mechanism in an unlocked state thereof;

FIG. 11 is a partially transparent perspective view of the hinge assembly of FIG. 9 with the retention mechanism in the unlocked stated;

FIG. 12 is a rear perspective view of a bottom end portion of the pivot door system of FIG. 3 with the primary panel and the secondary panel hidden and with a lower retainer of the retention mechanism extended;

FIG. 13 is a rear perspective view of the bottom end portion of the pivot door system of FIG. 12 with the retention mechanism in the unlocked state;

FIG. 14 is a flowchart illustrating a method of operating a pivot door in accordance with exemplary embodiments of the present disclosure;

FIG. 15 is a cross-sectional view of a lower pivot assembly, in accordance with exemplary embodiments of the present disclosure;

FIG. 16 is a front elevation view of a lower pivot member, in accordance with exemplary embodiments of the present disclosure;

FIG. 17 is a perspective view of a pivot ball member, in accordance with exemplary embodiments of the present disclosure;

FIG. 18 is a front elevation view of a lower pivot assembly offset from a vertical axis, in accordance with exemplary embodiments of the present disclosure;

FIG. 19 is a perspective view of an upper pivot pin, in accordance with exemplary embodiments of the present disclosure;

FIG. 20 is a perspective view of a pivot bushing, in accordance with exemplary embodiments of the present disclosure;

FIG. 21A is a front elevation view of a panel joining assembly, in accordance with exemplary embodiments of the present disclosure;

FIG. 21B is a front elevation closeup view of the panel joining assembly of FIG. 21;

FIG. 22 is a perspective view of the panel joining assembly of FIG. 21;

FIG. 23 is a cross-sectional view of the panel joining assembly of FIG. 21;

FIG. 24 is a perspective view of the panel joining assembly of FIG. 21 with additional post-extrusion processing in accordance with exemplary embodiments of the present disclosure; and

FIG. 25 is a cross-sectional view of the panel joining assembly of FIG. 24.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

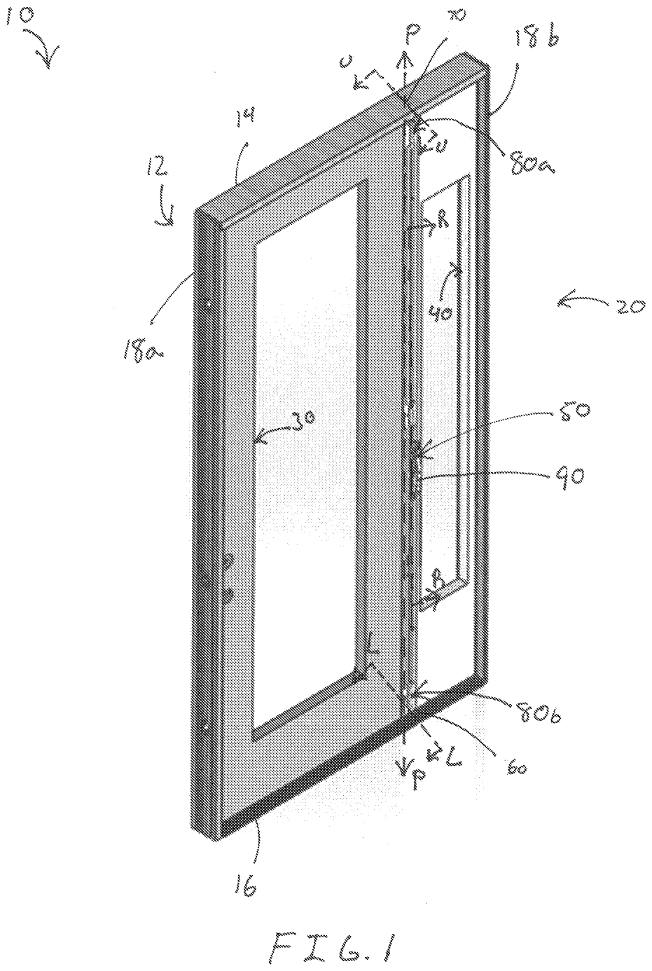

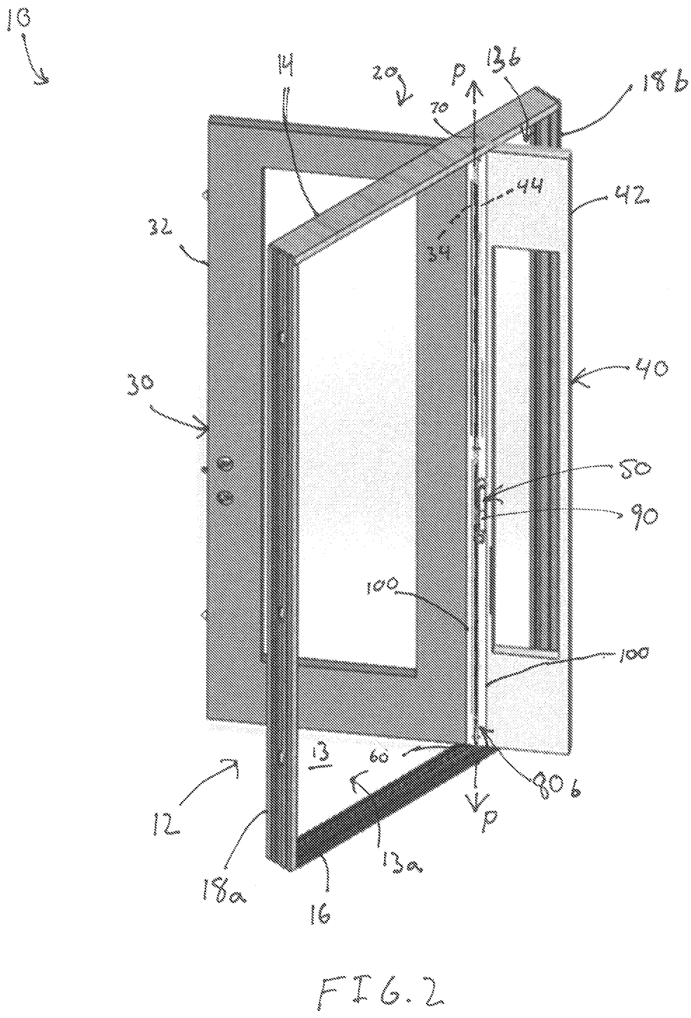

Referring now to FIGS. 1-3 a pivot door system 10 is provided in accordance with embodiments of the present disclosure. The pivot door system 10 includes a door frame 12 and a pivot door 20. The pivot door 20 has a primary panel 30, a secondary panel 40, and a pivot assembly 50. The primary panel 30 and the secondary panel 40 pivot in concert with each other relative to the door frame 12 between a closed position (FIG. 1) and a first open position (FIG. 2) to allow ingress and egress through the pivot door system 10. The secondary panel 40 has a second open position or vent position (FIG. 3) in which the secondary panel 40 rotates relative to the primary panel 30 of the pivot door 20.

The door frame 12 defines an opening 13 to receive the pivot door 20. The door frame 12 has a header 14, a sill 16, a primary jamb 18a, and a secondary jamb 18b with the opening 13 defined between the header 14, the sill 16, the primary jamb 18a, and the secondary jamb 18b. In some embodiments, the door frame 12 includes weather stripping that engages the pivot door 20 in the closed position and forms a weather resistant seal between the door frame 12 and the pivot door 20.

The pivot door 20 is pivotally mounted in the door frame 12 to allow the primary panel 30 and the secondary panel 40 to pivot between the open and closed positions about a pivot axis P-P defined by the pivot assembly 50. The pivot assembly 50 is substantially disposed between and secured to the primary panel 30 and the secondary panel 40. The pivot assembly 50 mounts both the primary panel 30 and the secondary panel 40 to the door frame 12. The pivot axis P-P extends between the header 14 and the sill 16 parallel to the primary jamb 18a and the secondary jamb 18b. The pivot axis P-P may be disposed between the primary jamb 18a and the secondary jamb 18b. In the first open position, the pivot door 20 may divide the opening 13 to define a door passage 13a and a secondary passage 13b. The door passage 13a is defined between the primary jamb 18a and the pivot axis P-P. The secondary passage 13b is defined between the secondary jamb 18b and the pivot axis P-P. In the second open position, the secondary panel 40 rotates relative to the primary panel 30 to define the secondary passage 13b.

In the closed position, the primary panel 30 and the secondary panel 40 may be aligned with each other such that both the primary panel 30 and the secondary panel 40 are within the thickness of the door frame 12 to fill the opening 13. The thickness of the door frame 12 is defined by the greater of the thickness of the jambs 18a, 18b, the header 14, and the sill 16 with the thickness being defined in a direction orthogonal to an opening plane defined between the jambs 18a, 18b, the header 14, and the sill 16. In the first open position, the primary panel 30 and the secondary panel 40 may be aligned with each other and positioned partially outside the thickness of the door frame 12 to divide the opening 13 into the door passage 13a and the secondary passage 13b. In the second open position, the primary panel 30 and the secondary panel 40 may be out of alignment and askew with each other with at least one of the primary panel 30 or the secondary panel 40 positioned partially outside the thickness of the door frame 12 to divide the opening 13 into the door passage 13a and the secondary passage 13b.

In some embodiments, the primary panel 30 is a standard hinged door panel compatible with standard door hardware, e.g., doorknobs and deadbolts. The primary panel 30 may have a lock edge 32 that is machined to be compatible with multipoint lock systems. For example, a multipoint lock system may include auxiliary latches to deploy from the lock edge 32 and engage the primary jamb 18a, or may include shoot bolts to deploy from a top or bottom edge of the primary panel 30 and engage the header 14 or the sill 16.

In certain embodiments, the pivot door system 10 includes a retractable screen to extend across the secondary passage 13b when the pivot door 20 is in the second open position. The retractable screen may be disposed within the primary panel 30, the secondary panel 40, the pivot assembly 50, or the secondary jamb 18b.

Continuing to refer to FIGS. 1-3, the pivot assembly 50 includes a lower pivot 60, an upper pivot 70, a hinge assembly 80, and a retainer mechanism 90. The pivot assembly 50 pivotally mounts the pivot door 20 to the door frame 12 and rotatably secures the secondary panel 40 to the primary panel 30. The pivot assembly 50 rotatably secures the primary panel 30 and the secondary panel 40 to each other such that in the closed position, the inside face of the secondary panel 40 is parallel with the inside face of the primary panel 30 and the outside face of the secondary panel 40 is parallel with the outside face of the primary panel 30. In some embodiments, in the closed position, the inside face of the secondary panel 40 is coplanar with the inside face of the primary panel 30 and the outside face of the secondary panel 40 is coplanar with the outside face of the primary panel 30. When the pivot door 20 moves towards the first open position the secondary panel 40 pivots about the pivot axis P-P in concert with the primary panel 30 such that the inside face of the secondary panel 40 remains parallel with the inside face of the primary panel 30 and the outside face of the secondary panel 40 remains parallel with the outside face of the primary panel 30. In the second open position, the secondary panel 40 is askew from and out of alignment with the primary panel 30 with neither the inside face nor the outside face of the secondary panel 40 remaining parallel to the inside face or the outside face of the primary panel 30.

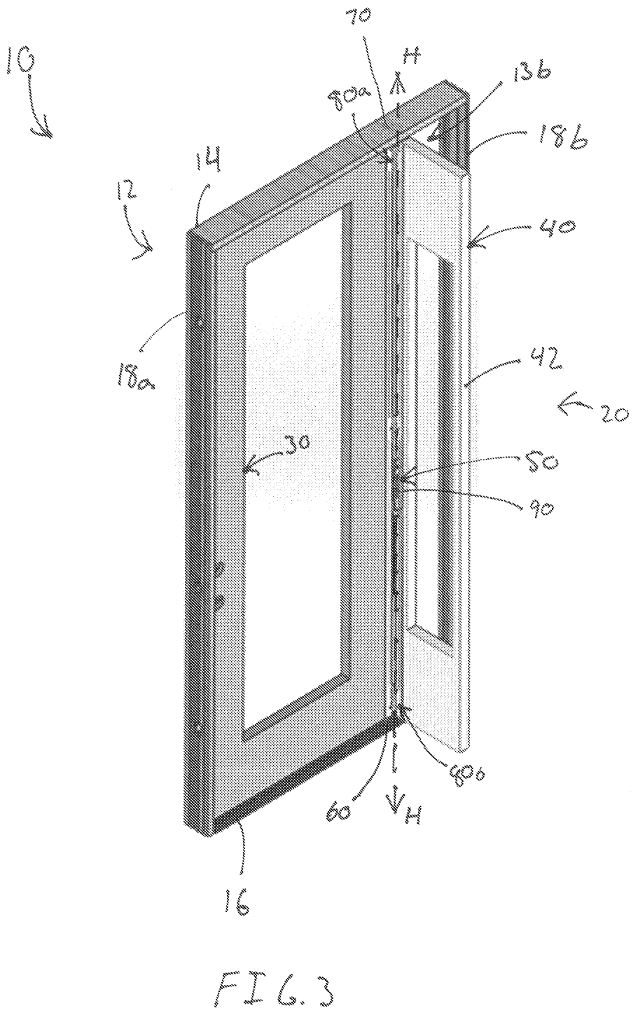

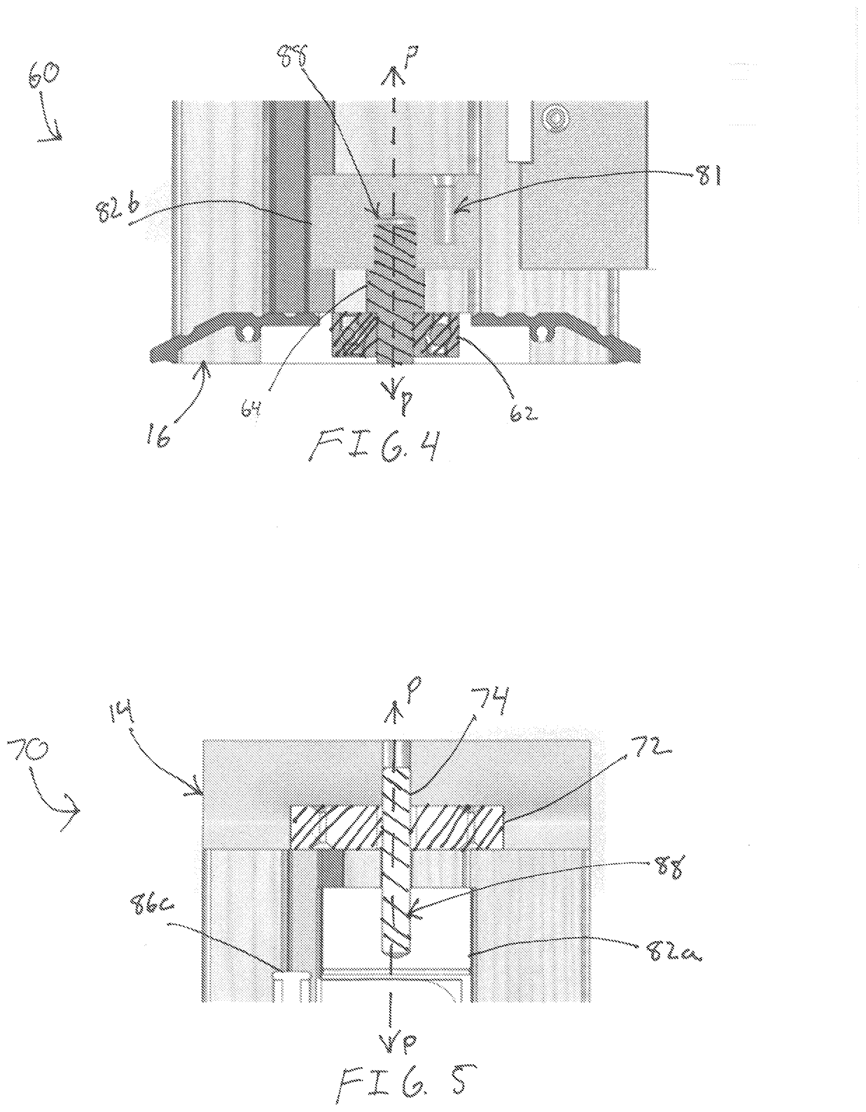

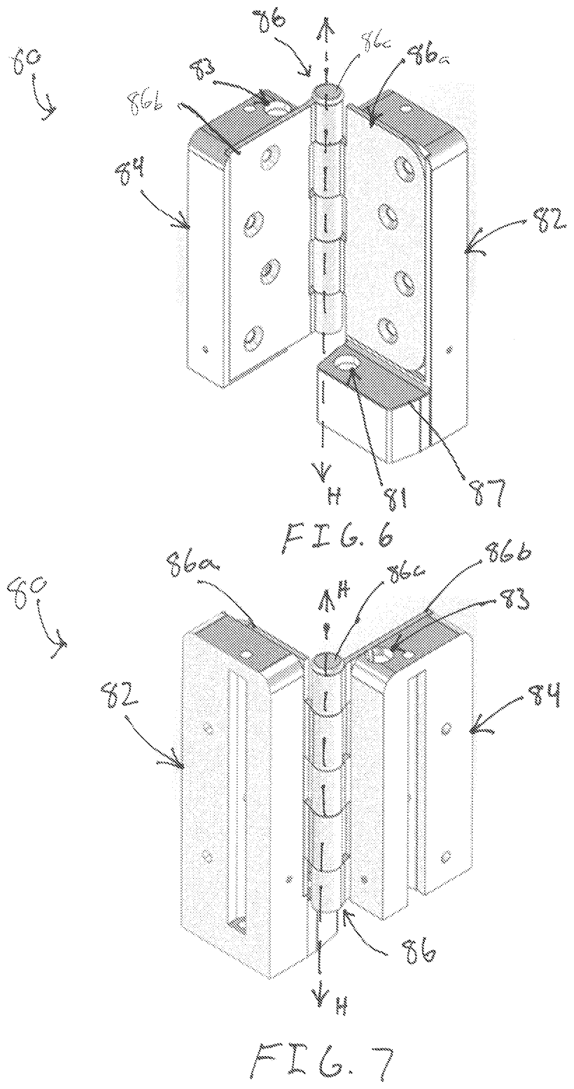

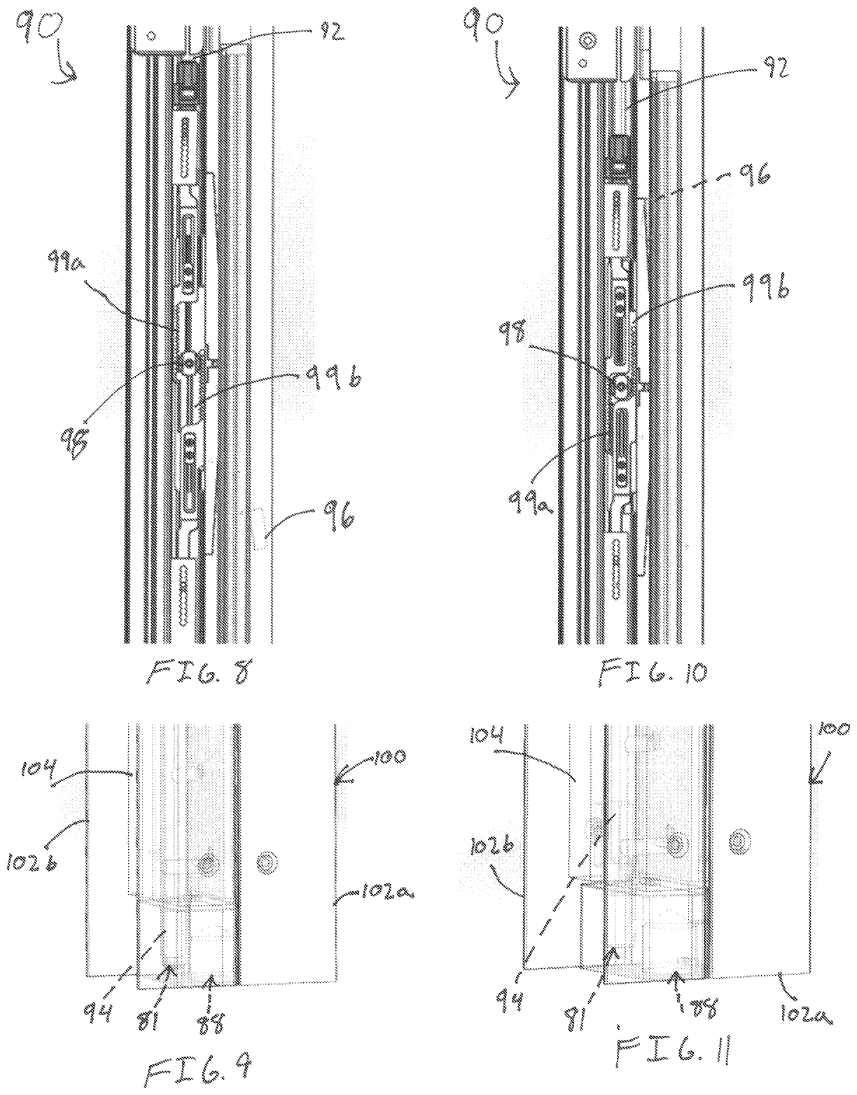

With particular reference to FIG. 4, a lower pivot 60 includes a lower bearing 62 and a lower pivot pin 64. The lower pivot 60 positions and retains the lower portion of the pivot door 20 within the door frame 12, allows pivoting of the pivot door 20 relative to the door frame 12, and supports the weight of the pivot door 20. The lower bearing 62 is disposed within the sill 16 and receives the lower pivot pin 64 to pivotally mount the lower portion of the pivot door 20 to the door frame 12. The lower bearing 62 may be a combination rotary bearing and thrust bearing, providing rotation and axial support. In certain embodiments, the lower bearing 62 includes a rotary bearing and a separate thrust bearing. In some embodiments, the lower pivot pin 64 may include a shoulder to support the pivot door 20 and to position the bottom edge of the pivot door 20 from the sill 16.

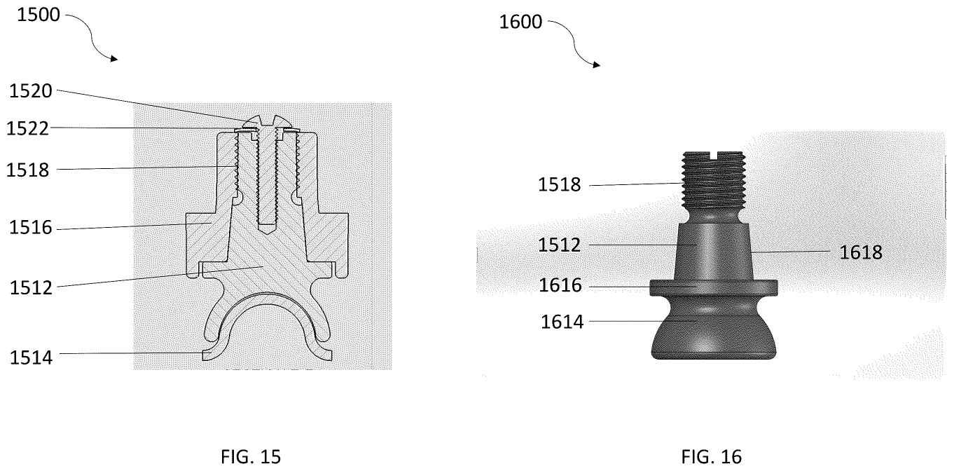

Referring now to FIG. 15, another exemplary lower pivot assembly is generally shown at 1500 in a front elevation cross section. In relevant part, the lower pivot assembly includes a lower pivot 1512, set over a pivot ball 1514 with a bushing 1516 installed thereon via outer pivot threads 1518 and exemplary threaded member 1520. A washer is also illustrated at 1522. Certain individual components will first be described, followed by a description of interrelation of those components as it relates to installation and performance.

Referring now to FIG. 16, the exemplary lower pivot 1512 is shown in a front elevation view. As can be seen, the lower pivot includes a lower portion 1612 that is configured to sit on and movably engage the ball. In the illustrated exemplary embodiment, a negative (concave) shape is provided therein to engage the rounded shape of ball 1514. As will be seen below, among other things, this aspect improves the installation tolerances and long-term performance of the door, e.g., if frames or other aspects shift, in windy conditions, etc. The illustrated exemplary lower pivot is also designed so that oil impregnated materials can be used to decrease friction and corrosion resistance, with the lower portion/cup 1612 configured to glide across the raised pivot ball surface since the axis of the door is intersecting the center of the ball, reducing or eliminating any offset loading condition from the system.

Referring still to FIG. 16, a shelf portion 1616 is also illustrated to facilitate installation of bushing 1516 (along with lower pivot threads 1518). Above the shelf portion 1616 is a tapered region 1618 configured to prevent wobble during rotation of the door (after installation in the bushing/housing 1516), providing a smooth and effortless swinging of the door panel.

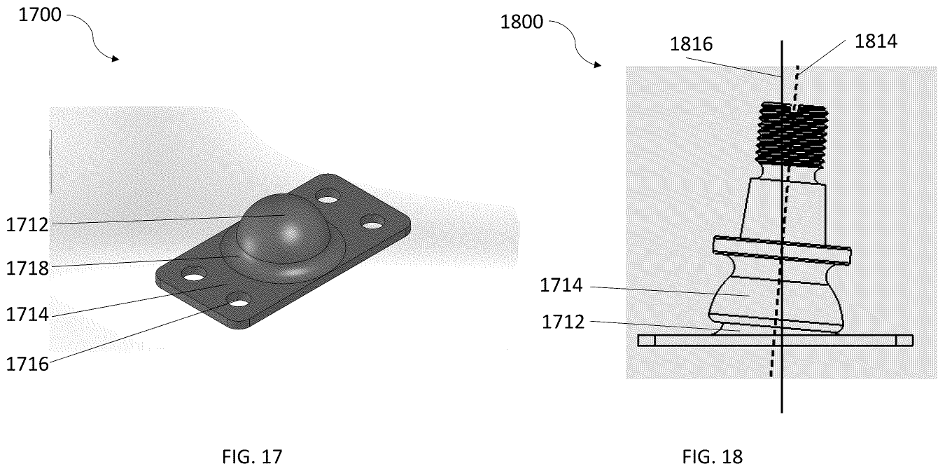

Referring now to FIG. 17, the exemplary pivot ball 1514 is shown at 1700 in perspective. The illustrated exemplary pivot ball 1700 includes a rounded (ball) portion 1712, a flat installation portion 1714, with fastener apertures 1716 configured to be installed on a frame, sill, etc. and a transition region 1718 between the rounded portion and the flat portion. In exemplary embodiments, the pivot ball can be a stamped product, e.g., made from a stainless steel such as 300 stainless steel, which will work harden during the forming process, giving the ball a smooth, uniform hard surface to improve the wear characteristics of the ball.

FIG. 18 illustrates generally at 1800 how the interface between the cup/lower portion 1714 of the lower pivot and the pivot ball 1712 can compensate for off angles, e.g., as shown in the exemplary figures at around 5 degrees (shown as the off vertical axis line 1814 relative to the shown vertical line 1816. This provides a constrained ball and floating pivot, held in place by the mass of the door panel, which creates the vertical axis. The ball and pivot can rotate around each other, even if the axis is angles. While the illustrated exemplary embodiment in FIG. 18 is 5 degrees, the tolerance need for most doors and frame are typically between around 1/32 of an inch to 1/16 of an inch for locational tolerance, though other ranges are contemplated herein. Indeed, those lower variations in offset (e.g., 1/16 of an inch) due to manufacturing or installation issues would not create the same issues of misalignment and friction that typical hinges or pin to pin pivot mechanisms exhibit. Regardless, the above and other aspects of the present disclosure provide improvements even for pivot door installations.

Referring to FIG. 5, an upper pivot 70 includes an upper bearing 72 and an upper pivot pin 74. The upper pivot 70 positions and retains the upper portion of the pivot door 20 within the door frame 12 and allows pivoting of the pivot door 20 relative to the door frame 12. The upper bearing 72 is disposed in the header 14 and receives the upper pivot pin 74 to pivotally mount the upper portion of the pivot door 20 to the door frame 12. The upper pivot pin 74 and the lower pivot pin 64 are coaxially aligned with one another to define the pivot axis P-P. The upper pivot pin 74 may be smaller than the lower pivot pin 64, or may be substantially similar to the lower pivot pin 64 such that the upper pivot pin 74 and the lower pivot pin 64 are interchangeable. The upper bearing 72 may be a rotary bearing, e.g., a ball bearing or a roller bearing.

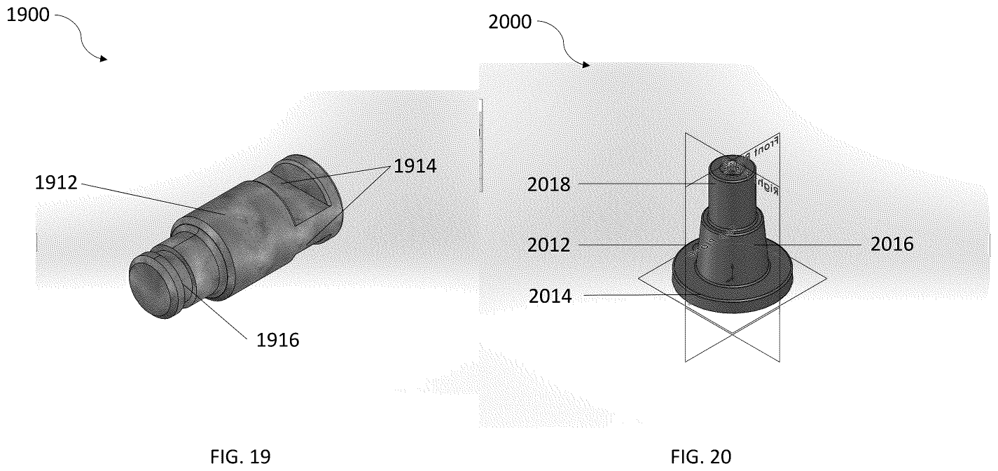

Referring to FIGS. 19 and 20, another exemplary upper pivot is generally illustrated at 1900 and 2000, respectively. FIG. 19 illustrates an exemplary pivot pin 1912, having one or more grooves 1914, 1916 cut into it or otherwise provided in it, e.g., for engagement with a bearing in the header, as above and/or a bushing in the door panel. A groove, e.g., 1912 may provide grip if a door panel begins to deflect (bow) under wind loads. In exemplary aspects, the pivot pin 1912 is a heat treated material for wear resistance and for strength.

FIG. 20 illustrates a pivot pin bushing/upper receiver 2012 for the pivot pin 1912, configured to engage the pivot pin such that oil impregnated materials can be used to decrease friction and corrosion resistance. An illustrated top annular member is illustrated at 2014. A tapered region is illustrated at 2016, configured such that when it is installed in the housing, it will not wobble during rotation of the door, providing a smooth, effortless swinging of the door panel. A lower portion is illustrated at 2018.

With reference to FIGS. 6 and 7, a lower hinge assembly 80b is described in accordance with the present disclosure. The hinge assembly 80 includes the lower hinge assembly 80b and an upper hinge 80a which may be similar to the lower hinge assembly 80b with features moved or relocated to allow for alignment of features. For example, in certain embodiments, the upper hinge assembly 80a may be interchangeable with the lower hinge assembly 80b by rotation 180 degrees about the horizontal axis thereof and may have some features mirrored across the central plane of the hinge assembly 80. For the purpose of clarity and brevity only the lower hinge assembly 80b is described in detail herein.

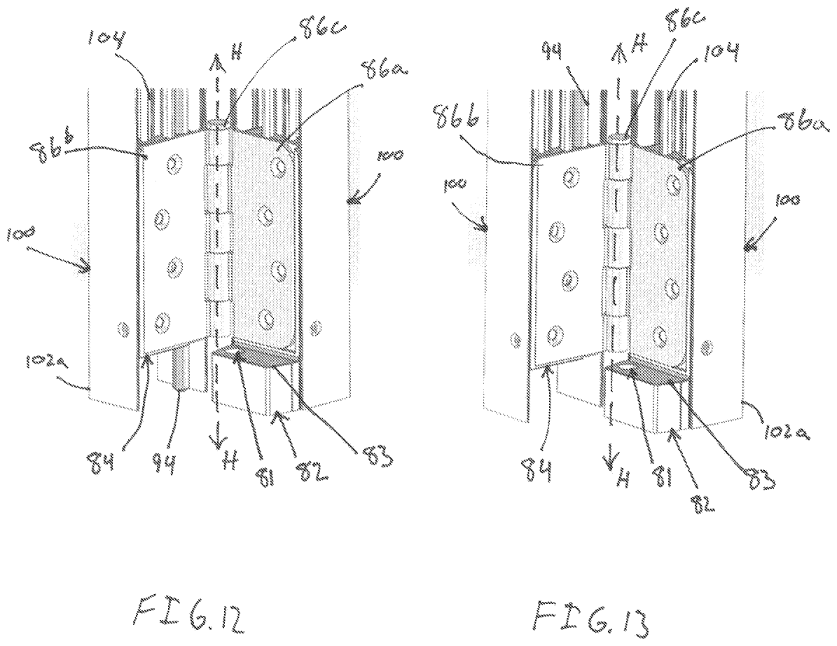

The lower hinge assembly 80b includes a door anchor 82, a secondary anchor 84, and an auxiliary hinge 86. The hinge assembly 80 pivotally mounts the primary panel 30 and the secondary panel 40 to the door frame 12 and rotatably secures the primary panel 30 and the secondary panel 40 to each other. The door anchor 82 attaches to a primary panel pivot edge 34 of the primary panel 30 and receives the lower pivot pin 64 to pivotally mount the primary panel 30 to the door frame 12. The door anchor 82 includes a vertical member and a horizontal member or ledge 87 such that the door anchor 82 is substantially L-shaped. On the underside of the ledge 87, the door anchor 82 defines a pivot pin cavity 88 (FIG. 4) to receive the lower pivot pin 64. The upper side of the ledge 87 defines a lock hole 81 that extends into the ledge 87 and is offset from the pivot pin cavity 88. The lock hole 81 may be a blind hole or a through hole. In certain embodiments, the door anchor 82 may include more than one lock hole 81. The lock hole 81 may be offset from the pivot pin cavity 88 such that the lock hole 81 is out of communication with the pivot pin cavity 88. In some embodiments, the door anchor 82 may include a chamfer or a countersink disposed about the lock hole 81 to guide a retainer 92, 94 (FIG. 12) into the lock hole 81 as detailed below.

The secondary anchor 84 is attached to a secondary panel pivot edge 44 of the secondary panel 40. The secondary anchor 84 is sized and dimensioned to nest within the L-shape of door anchor 82 to form a substantially rectangular block therewith when the primary panel 30 and the secondary panel 40 are aligned with each other. The secondary anchor 84 defines a guide hole 83 that extends therethrough. When the secondary panel 40 nests within the L-shape of the door anchor 82, the guide hole 83 is coaxially aligned with the lock hole 81. The chamfer may compensate for minor misalignments between a guide hole 83 and the lock hole 81 to guide a respective retainer 92, 94 into the lock hole 81.

The auxiliary hinge 86 secures the door anchor 82 and the secondary anchor 84 to each other and defines the hinge axis H-H parallel to the pivot axis P-P. The secondary panel 40 rotates relative to the primary panel 30 about the hinge axis H-H. The hinge axis H-H may be offset from the pivot axis P-P. In embodiments, the hinge axis H-H may be offset from the pivot axis P-P in a lateral direction, towards or away from the jambs 18a, 18b, or in an inward/outward direction, that passes through the door frame 12 perpendicular to the lateral direction. In some embodiments, the hinge axis H-H may be outside a thickness of the pivot door 20. In certain embodiments, the hinge axis H-H and the pivot axis P-P may be coaxial with one another.

The auxiliary hinge 86 attaches to the door anchor 82 by a first flange 86a and to the secondary anchor 84 by a second flange 86b. A hinge pin 86c couples the first flange 86a and the second flange 86b and defines the hinge axis H-H along a central longitudinal axis thereof. The auxiliary hinge 86 may be a standard door hinge. In some embodiments, the flanges 86a, 86b of the auxiliary hinge 86 may be unitarily formed with the respective anchors 82, 84.

Referring to FIGS. 8-11, the retainer mechanism 90 of the pivot assembly 50 is described in accordance with the present disclosure. The retainer mechanism 90 has a locked state (FIGS. 8 and 9) in which the secondary panel 40 is prevented from rotating relative to the primary panel 30 and an unlocked state (FIGS. 10 and 11) in which the secondary panel 40 is allowed to rotate relative to the primary panel 30. The retainer mechanism 90 includes an upper retainer 92, a lower retainer 94, and a lock lever 96. The upper retainer 92 and the lower retainer 94 are selectively translated by the lock lever 96 between the locked state and the unlocked state. In the locked state, the retainers 92, 94 extend into the door anchors 82 of the upper hinge assembly 80a and the lower hinge assembly 80b, respectively, to prevent rotation of the secondary anchor 84 with respect to the door anchor 82, and thus, preventing rotation of the secondary panel 40 relative to the primary panel 30. In the locked state, the retainers 92, 94 extend from the guide hole 83 of the secondary anchor 84 and into the lock hole 81 such that a lock end portion of the respective retainer 92, 94 is disposed within the lock hole 81 of the door anchor 82. In the unlocked state, the retainers 92, 94 are withdrawn from the respective door anchor 82. In some embodiments, the lock end portions of the retainers 92, 94 are disposed within the guide hole 83 of a respective secondary anchor 84 to allow the secondary panel 40 to rotate relative to the primary panel 30.

The retainer mechanism 90 is attached to the secondary panel pivot edge 44 with the lock lever 96 located along the secondary panel pivot edge 44. In some embodiments, the lock lever 96 is located medially along the secondary panel pivot edge 44. The upper retainer 92 includes a rack 99a and the lower retainer 94 includes a rack 99b. The racks 99 may be disposed on a rack end portion of each of the retainers 92, 94. The racks 99 mesh with a gear 98 operably coupled to the lock lever 96 such that actuation of the lock lever 96 rotates the gear 98 to translate the retainers 92, 94 between the locked state and the unlocked state. Actuation of the lock lever 96 may translate the retainers 92, 94 simultaneously. For example, actuation of the lock lever 96 may cause rotation of the gear 98 in a counterclockwise direction and may translate the upper retainer 92 upwards and the lower retainer 94 downwards simultaneously. In some embodiments, the retainer mechanism 90 may be attached to the primary panel pivot edge 34 (FIG. 2). In certain embodiments, the retainer mechanism 90 may include a lockout mechanism to prevent translation of the retainers 92, 94 by the lock lever 96 when the primary panel 30 and the secondary panel 40 are in the first open position.

In some embodiments, the pivot assembly 50 may include a third hinge assembly, a fourth hinge assembly, or more than four hinge assemblies. The number of hinge assemblies 80 may be dictated by the size or the weight of the secondary panel 40. In embodiments including more than two hinge assemblies 80, the other hinge assemblies may be configured to avoid interference with the operation of the secondary panel 40 and the retainer mechanism 90. For example, the other hinge assemblies may include holes, slots, or channels to accommodate passage and operation of the retainers 92, 94 therethrough to the upper and lower hinge assemblies 80a, 80b, and/or may have the ledge 87 removed.

Referring to FIGS. 2, 12, and 13, the pivot assembly 50 may include a pair of leaves 100. Either leaf 100 of the pair of leaves 100 may house the retainer mechanism 90. Housing the retainer mechanism 90 in a leaf 100 may protect the moving components of the retainer mechanism 90 from environmental debris. Housing the retainer mechanism 90 in a leaf 100 may conceal components of the retainer mechanism 90. The pair of leaves 100 may mate with each other to form a weather resistant seal between the secondary panel 40 and the primary panel 30.

Each leaf 100 may include shell members 102a and 102b and an edge plate 104 extending between the shell members 102a, 102b, forming a substantially H-shaped profile. One leaf 100 of the pair of leaves 100 is secured to the primary panel pivot edge 34 and the other is secured to the secondary panel pivot edge 44. Each leaf 100 of the pair of leaves 100 is secured to the primary panel 30 or the secondary panel 40 by the edge plate 104. Each leaf 100 of the pair of leaves 100 is sized and dimensioned such that when secured to the primary panel 30 or the secondary panel 40 the shell members 102a, 102b receive a respective panel pivot edge 34, 44 of a respective panel 30, 40 and a respective anchor 82, 84 of the panels 30, 40 therebetween. The edge plate 104 may include an insulative member to act as a thermal break to resist heat transfer across the leaf 100 from outside to inside, or vice versa. In some embodiments, the pair of leaves 100, the primary panel 30, or the secondary panel 40 includes a cover (not shown) to cover and conceal the retainer mechanism 90. Each leaf 100 of the pair of leaves 100 may be formed as a unitary or monolithic structure, e.g., as an extrusion that is cut to length. In some embodiments, each leaf 100 of the pair of leaves 100 may be extruded in halves and joined together with the insulative member.

In certain embodiments, the pivot door 20 is configured such that components of the pivot assembly 50 may be hidden within the primary panel 30 or the secondary panel 40 without the leaves 100. In such embodiments, the primary panel pivot edge 34 and the secondary panel pivot edge 44 may mate such that the primary panel 30 and the secondary panel 40 are substantially seamless with one another. The primary panel 30 may be machined along the primary panel pivot edge 34 and the secondary panel 40 may be machined along the secondary panel pivot edge 44 so that each of the primary panel 30 and the secondary panel 40 define a cavity. The cavity defined by the primary panel 30 may receive the door anchor 82 and the cavity defined by the secondary panel 40 may receive the secondary anchor 84. Additionally or alternatively, the cavity defined in the primary panel 30 or the secondary panel 40 may receive the retainer mechanism 90. The lock lever 96 may be disposed through the primary panel 30 or the secondary panel 40 such that the lock lever 96 is capable of translating the retainers 92, 94 contained within the primary panel 30 or the secondary panel 40. In some embodiments, the cavity defined by the primary panel 30 or the secondary panel 40 may be offset from the primary panel pivot edge 34 or the secondary panel pivot edge 44 such that the cavity defines a tunnel extending from a top or bottom edge of a respective panel 30, 40 through the primary panel 30 or the secondary panel 40. In certain embodiments, the retainer mechanism 90 may include retainer docks to aid in the installation of the retainer mechanism 90 within the cavity defined by the primary panel 30 or the secondary panel 40. The retainer docks may be coupled to a respective rack 99a, 99b and translatable therewith when the retainer mechanism 90 transitions between the locked state and the unlocked state. The retainer docks are configured to receive the rack end portion of the retainers 92, 94 and operably couple the retainers 92, 94 to the retainer mechanism 90.

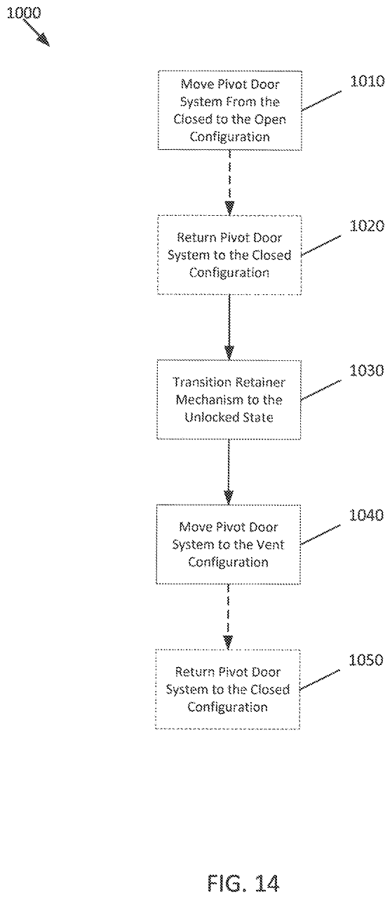

With reference to FIG. 14, a method 1000 of operating the pivot door system 10 is described in accordance with the present disclosure with reference to the pivot door system 10 of FIGS. 1-13. To begin, the pivot door system 10 is in a closed configuration in which the primary panel 30 and the secondary panel 40 are in the closed position and the retainer mechanism 90 is in the locked state. In the closed configuration, the primary panel 30 and the secondary panel 40 may substantially fill or substantially close the opening 13.

The door panel system 10 is pivoted from the closed position towards a first open configuration in which the primary panel 30 and the secondary panel 40 are in the first open position (Step 1010). To pivot the door panel system 10 towards the first open configuration, a handle of the primary panel 30 may be actuated to allow the pivot door system 10 to pivot from the closed configuration. When the pivot door system 10 moves to the first open configuration, the primary panel 30 and the secondary panel 40 pivot about the pivot axis P-P such that the primary panel 30 and the secondary panel 40 remain aligned with each other to divide the opening 13 into the door passage 13a and the secondary passage 13b. In some embodiments, when the pivot door system 10 moves to the first open configuration the primary panel 30 and the secondary panel 40 pivot to opposite sides of the door frame 12. The door frame 12 defines an interior side and an exterior side. In embodiments, the pivot door 20 may be an outswing pivot door with the primary panel 30 pivoting towards the exterior side of the door frame 12 and the secondary panel 40 pivoting in concert towards the interior side of the door frame 12 in the first open position. In some embodiments, the pivot door 20 may be an inswing pivot door with the primary panel 30 pivoting toward the interior side of the door frame 12 and the secondary panel 40 pivoting in concert towards the exterior side of the door frame 12. In certain embodiments, the pivot door 20 may be both an inswing and an outswing pivot door.

The pivot door system 10 may be returned to the closed configuration by pivoting the pivot door 20 into the closed configuration until the primary panel 30 and the secondary panel 40 return to the respective closed positions thereof (Step 1020). Returning the pivot door system 10 to the closed configuration from the first open configuration may include pivoting the pivot door 20 towards the door frame 12 to reengage the door hardware with the door frame 12.

The retainer mechanism 90 may be actuated to transition from the locked state to the unlocked state (Step 1030). For example, the lock lever 96 of the retainer mechanism 90 may be actuated to transition the retainer mechanism 90 from the locked state to the unlocked state. With the retainer mechanism 90 in the unlocked state, the pivot door system 10 is moved to a second open configuration in which the secondary panel 40 is rotated relative to the primary panel 30 to the second open position (Step 1040). When the pivot door system 10 moves to the second open configuration, the secondary panel 40 is rotated relative to the primary panel 30 about the hinge axis H-H such that the secondary panel 40 and the primary panel 30 are out of alignment with each other. In the second open configuration, the primary panel 30 and the secondary panel 40 may divide the opening 13 into the door passage 13a and the secondary passage 13b. As the secondary panel 40 is rotated to the second open position, rotation of the secondary panel 40 relative to the primary panel 30 may be limited by a stop mechanism askew from the primary panel 30 in a rotation range of 5 degrees to 90 degrees, e.g., 5, 10, 15, 20, 25, 30, 35, or 45 degrees. The stop mechanism may be a hard stop disposed on either the primary panel 30 or the secondary panel 40, or the stop mechanism may be a mechanical or electrical mechanism included in the pivot assembly 50. In some embodiments, the stop mechanism may be configured to hold the secondary panel 40 at a desired angle relative to the primary panel 30. For example, the stop mechanism may include a gas strut to hold the secondary panel 40 at any desired angle in the rotation range. In certain embodiments, the method includes deploying a retractable screen across the secondary passage 13b when the secondary panel 40 is in an open position. The retractable screen may be manually deployable or automatically deployed. In some embodiments, the retractable screen may be deployed by a powered mechanism.

The pivot door system 10 may be returned to the closed configuration by pivoting the pivot door 20 into the closed configuration until the primary panel 30 and/or the secondary panel 40 return to the respective closed positions thereof (Step 1050). Returning the pivot door system 10 to the closed configuration from the second open configuration may include rotating the secondary panel 40 relative to the primary panel 30 such that the inside face of the secondary panel 40 and the inside face of the primary panel 30 are parallel and then actuating the lock lever 96 to transition the retainer mechanism 90 to the locked state.

Although the method steps are described in a specific order, it should be understood that other steps may be performed in between described steps, described steps may be adjusted so that they occur at slightly different times, or the described steps may occur in any order unless otherwise specified.

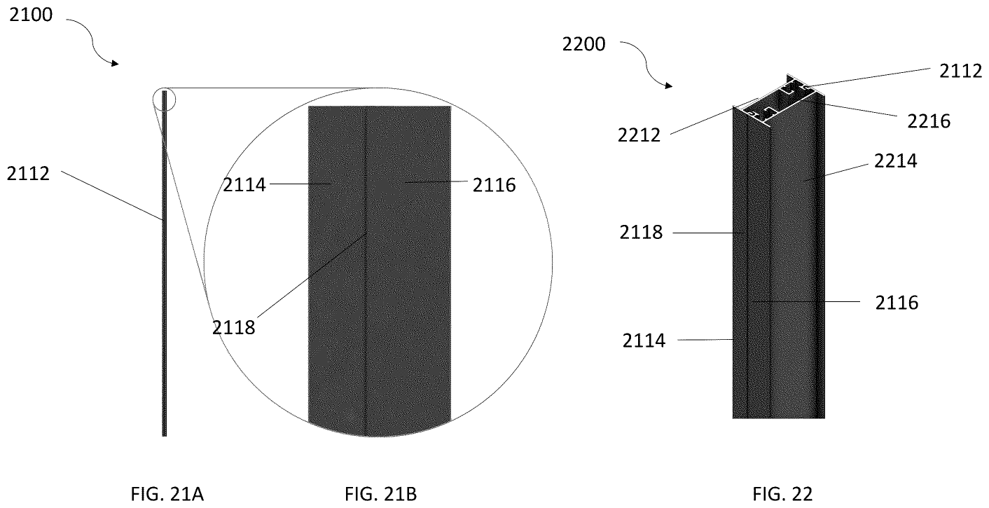

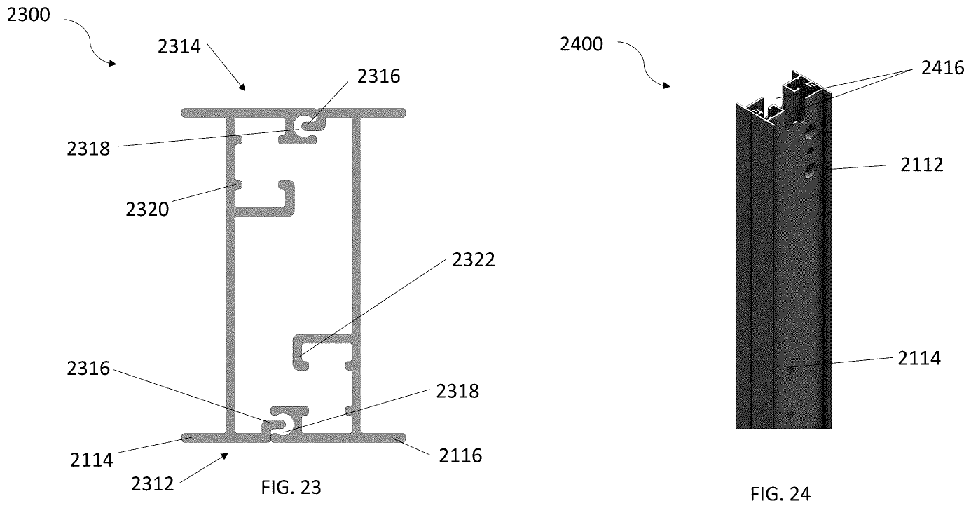

FIGS. 21A and 21B illustrate a front elevation view and a closeup of that front elevation view, respectively, of an exemplary joining assembly for panels generally at 2100. The joining assembly 2100 includes a first panel joining member 2114, a second panel joining member 2116 and a seam 2118, therebetween. As will be discussed below, such joining members provide a minimal seam for the joining of two panels. We note that in the illustrated exemplary embodiment, the first joining member has a different width on the illustrated front side from the second joining member, though this is not necessary. In exemplary embodiments, and as is illustrated in the cross-sectional view of FIG. 23, the joining members 2114 and 2116 can each have a narrow facing side and a wide facing side, so that the same piece could be used in duplicate, but in reversed orientation, for the assembly of two pieces. This also serves to offset the front and back seams 2118 for the joined panels.

FIG. 22 illustrates an exemplary joining assembly, as in FIGS. 21A and 21B, in perspective view. Panel joining interfaces 2212 and 2214, configured e.g., as channels, to engage respective panels can be seen in the perspective. Additionally, exemplary interior walls 2216 can be seen in FIG. 22 and is illustrated again by the cross-sectional view of FIG. 23.

Referring now to FIG. 23, an exemplary cross-sectional profile of two joining members is illustrated generally at 2300. As in FIGS. 21A, 21B and 22, the front face 2312 of joining member 2114 is more narrow across the front face than that of joining member 2116. The reverse is true on the back face 2314, with joining member 2114 being wider than joining member 2116 on that back face 2314. Also, each of joining members 2114 and 2116 include one side having a protrusion 2316, configured here as an exemplary fin, and an opposite second side having a recess 2318, configured here as an exemplary circular cavity. In exemplary embodiments, one or both of the circular cavities includes a retaining member to engage and hold the protrusion of the opposing joining member, such as an extruded foam, an elastic cord or other material, provided at least partially along its length to hold the pieces together tightly. We also note that in the illustrated exemplary embodiment, the sight line/seams 2118 are reduced or eliminated by configuring the protrusion and recesses inwardly relative to the front and back faces, and thus away from cosmetic surfaces such that the surfaces become flush once the channels are joined. Additional exemplary stiffening ridges 2320 and other contours 2322 are also illustrated interior to each joining member.

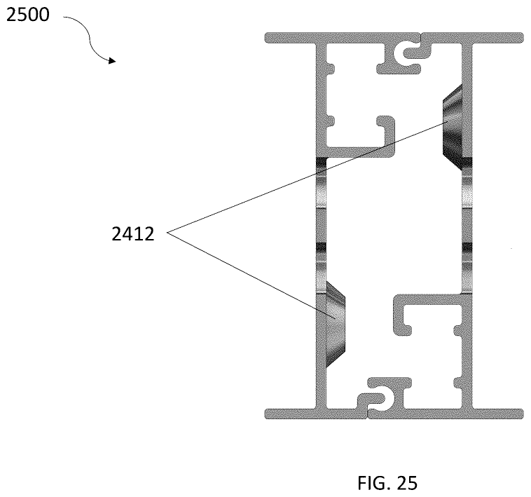

In further exemplary embodiments, the joining members are extruded pieces, e.g., extruded aluminum or other material. Additionally, alternate methods and mechanisms for joining panels to joining member recesses/panels are also contemplated, including gluing, use of fasteners, combinations of mechanisms etc. Additionally, punching or other operations (e.g., if extruded, other post-extrusion operations) are contemplated to provide apertures or punches for fasteners, for coin and slot locations, etc. For example, FIGS. 24 and 25 show perspective view (at 2400) and cross-sectional views (2500), respectively of assembled extrusions similar to those in FIGS. 22 and 23, with post-extrusion features, such as punched portions 2412, other apertures 2414, cutouts 2416, etc., as may be desired to assist in joining panels to the joining members or otherwise.

Also, referring back to FIGS. 1-3, in particular embodiments, the pivot door system 10 may be a powered door system including an energy transfer device and electrical components. The energy transfer device may transfer electrical energy and/or signals between the door frame 12 and the pivot door 20. The energy transfer device may transmit energy through a wired or a wireless connection. For example, the energy transfer device may include a cable that extends from the door frame 12 of the pivot door 20 to transfer energy and/or signals therebetween. In some embodiments, the energy transfer device may include inductive coils and receivers in the door frame 12 and/or the pivot door 20 to wirelessly transfer energy and/or signals therebetween.

The electrical components may aid in operation and expand the functionality of the pivot door system 10. The electrical components may be disposed within the door frame 12 or the pivot door 20. Electrical components may include, but are not limited to batteries, powered locks (e.g., push button, biometric reader, RFID reader), intercoms, cameras, lights, Wi-Fi modules, Bluetooth® modules, telecommunications modules (e.g., 3G, 4G, 5G), sensors (e.g., motion sensors, proximity sensors, contact sensors, pressure sensors), or digital displays. One or more of the electrical components may interface with devices remote from the pivot door system 10 including, but not limited to, a smartphone, a computer, or a smart home system or device.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A pivot door assembly comprising:
a primary panel having an inside face and an outside face opposite the inside face;
a secondary panel having an inside face and an outside face opposite the inside face; and
a pivot assembly configured to pivotally mount the pivot door assembly within a door frame, the pivot assembly disposed between the primary panel and the secondary panel to rotatably secure the primary panel and the secondary panel to each other, the pivot assembly having a closed position in which the primary panel and the secondary panel are each engaged with the door frame with the inside face of the secondary panel parallel to the inside face of the primary panel, the pivot assembly having a first open position in which the primary panel and the secondary panel pivot away from the door frame with the inside face of the secondary parallel to the inside face of the primary panel, the pivot assembly having a second open position in which the inside face of the primary panel and the inside face of the secondary panel are askew from one another.

2. The pivot door assembly according to claim 1, wherein when the pivot assembly is in the second open position the primary panel is engaged with the door frame.

3. The pivot door assembly according to claim 1, wherein the pivot assembly comprises a retainer mechanism having a locked state in which the pivot assembly is prevented from pivoting to the second open position and an unlocked state in which the pivot assembly is capable of pivoting to the second open position.

4. The pivot door assembly according to claim 1, wherein the pivot assembly comprises:
a door anchor attached to the primary panel defining a lock hole, the lock hole configured to receive a retainer to prevent movement of the pivot assembly to the second open position; and
a secondary anchor attached to the secondary panel defining a guide hole, the guide hole configured to guide the retainer into the lock hole.

5. The pivot door assembly according to claim 4, wherein the pivot assembly further comprises a retainer mechanism having a locked state in which the pivot assembly is prevented from pivoting to the second open position and an unlocked state in which the pivot assembly is capable of pivoting to the second open position, the retainer mechanism comprising:
a retainer disposed through the guide hole and received within the lock hole when the retainer mechanism is in the locked state, the retainer retracted from the lock hole and disposed within the guide hole when the retainer mechanism is in the unlocked state; and
a lock lever operably coupled to the retainer to translate the retainer in response to transitioning the retainer mechanism between the locked state and the unlocked state.

6. A pivot door system comprising:
a door frame; and
a pivot door assembly according to claim 1 pivotally mounted in the door frame.

7. A pivot hinge for a pivot door having a primary panel and a secondary panel, the pivot hinge comprising:
a pivot assembly configured to pivotally mount the primary panel and the secondary panel such that the primary panel and the secondary panel are capable of pivoting relative to a door frame about a pivot axis and capable of pivoting relative to each other about a hinge axis, the pivot assembly defining the pivot axis between the primary panel and the secondary panel such that the primary panel and the secondary panel are pivotable about the pivot axis, in concert with one another, the pivot assembly defining the hinge axis parallel to the pivot axis such that the secondary panel is pivotable about the hinge axis relative to the primary panel; and
a retainer mechanism disposed between the primary panel and the secondary panel having a locked state in which the pivot assembly is configured to pivot the primary panel and the secondary panel in concert with one another and an unlocked state in which the pivot assembly is configured to allow the secondary panel to pivot relative to the primary panel.

8. The pivot hinge according to claim 7, wherein the pivot assembly is configured to constrain pivoting of the secondary panel relative to the primary panel to be within a predetermined angle, the predetermined angle defined between the primary panel and the secondary panel.

9. The pivot hinge according to claim 8, wherein the predetermined angle is 90 degrees or less.

10. A pivot door assembly comprising:
a primary panel;
a secondary panel; and
a pivot assembly configured to pivotally mount the pivot door assembly within a door frame defining an opening, the pivot assembly disposed between the primary panel and the secondary panel to rotatably secure the primary panel and the secondary panel to each other, the pivot assembly having a closed position in which the primary panel and the secondary panel are configured to align with each other within a thickness of the door frame to fill the opening, the pivot assembly having a first open position in which the primary panel and the secondary panel are configured to pivot within the opening aligned with each other such that the opening is divided by the primary panel and the secondary panel with each of the primary panel and the secondary panel extending partially outside the thickness of the door frame, the pivot assembly having a second open position in which the primary panel and the secondary panel rotate relative to each other such that the primary panel and the secondary panel are askew from one another and are configured pivot within the opening to divide the opening with at least one of the primary panel or the secondary panel extending partially outside the thickness of the door frame.

11. A method of operating a pivot door system including a door frame and pivot door pivotally mounted in the door frame, the method comprising:
moving the pivot door system from a closed configuration to a first open configuration thereof;
transitioning a retainer mechanism of the pivot door to an unlocked state thereof; and
moving the pivot door system to a second open configuration thereof.

12. The method according to claim 11, further comprising returning the pivot door system to the closed configuration before transitioning the retainer mechanism to the unlocked state.

13. A pivot door assembly comprising:
a primary panel having an inside face and an outside face opposite the inside face;
a secondary panel having an inside face and an outside face opposite the inside face;
a joining assembly configured to join the primary panel and the secondary panel to one another, the primary panel, secondary panel and joining assembly comprising the pivot door; a
a lower pivot assembly configured to pivotally mount the pivot door within a door frame, lower pivot assembly comprising a lower pivot member having a concavity configured to nest on a pivot ball, the pivot ball configured to mount within a bottom portion of the door frame, the lower pivot member configured to attach to the pivot door; and
an upper pivot assembly comprising a pivot pin configured to connect an upper portion of the pivot door to an upper portion of the door frame;
the lower pivot assembly and the upper pivot assembly configured to provide an axis of rotation for the pivot door within the door frame.

14. A pivot door assembly in accordance with claim 13, wherein lower pivot member is configured to attach to the bottom portion of the pivot door via a housing configured to attach the lower pivot assembly to the bottom portion of the pivot door.

15. A pivot door assembly in accordance with claim 13, wherein the lower pivot member and the pivot ball are configured as a floating assembly to allow for up to five degrees of operation off the vertical axis due to door tolerances.

16. A pivot door assembly in accordance with claim 15, wherein the pivot assembly is configured to allow for up to 1/16 of an inch of off-axis operation.

17. A pivot door assembly in accordance with claim 13, wherein the lower pivot assembly is configured such that oil impregnated materials are used and retained to allow the concavity to glide across the ball surface, eliminating offset loading.

18. A pivot door assembly comprising:
a primary panel having an inside face and an outside face opposite the inside face;
a secondary panel having an inside face and an outside face opposite the inside face;
a joining assembly configured to join the primary panel and the secondary panel to one another, the primary panel, secondary panel and joining assembly comprising the pivot door;
wherein the joining assembly comprises two complementary joining members, including first and second joining members, each joining member comprising:
a front face;
a back face;
a channel configured to receive a panel;
a protrusion on one end portion of the joining member; and
a concavity on an opposing end portion of the joining member; and
wherein the concavity on the first joining member is configured to mate with and retain the protrusion of the second joining member while the concavity on the second joining member is configured to mate with and retain the protrusion of the first joining member.

19. A pivot door in accordance with claim 18, wherein the protrusions of the first and second joining members and the concavities of the first and second joining members are recessed interiorly away from the front and back faces of the first and second joining members to provide for a minimal seam or sight line on each of the front and back faces of the joined first and second joining members.

20. A pivot door in accordance with claim 18, wherein the first and second joining members are extruded members.
